(19) United States
(12) Patent Application Publication
(10) Pub. No.: US 2023/0220131 A1
(43) Pub. Date: Jul. 13, 2023

(54) RESIN CONTAINING UNSATURATED GROUP, METHOD FOR PREPARING SAME, AND COMPOSITION COMPRISING SAME

(71) Applicant: KOLON INDUSTRIES, INC., Seoul (KR)

(72) Inventors: Sung Kyu KANG, Seoul (KR); Do Kyung SUNG, Seoul (KR); Guang Chun HUANG, Seoul (KR)

(21) Appl. No.: 17/997,539

(22) PCT Filed: Nov. 30, 2021
(86) PCT No.: PCT/KR2021/017897

§ 371 Date: Oct. 29, 2022

(30) Foreign Application Priority Data
Dec. 28, 2020 (KR) 10-2020-0185202

(51) Int. Cl. C08F 112/34; C08F 126/06

(52) U.S. Cl. CPC C08F 112/34; C08F 126/06; C08F 2800/20

(57) ABSTRACT

The present disclosure relates to an unsaturated group-containing resin, a method of preparing the same, and a composition including the same, wherein the unsaturated group-containing resin includes an oligomer represented by Chemical Formula 1 and an alkali metal ion, wherein an amount of the oligomer with n being 0 in Chemical Formula 1 is 80 wt % or less with respect to the total weight of the resin, and an amount of the alkali metal ion is 1 ppm to 30 ppm.

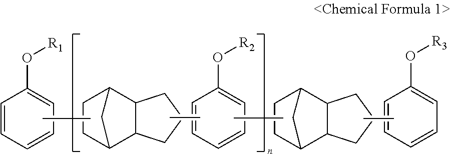

In Chemical Formula 1, R₁ to R₃ and n are as described in the present specification.

### TECHNICAL FIELD

The present disclosure relates to an unsaturated group-containing resin, a method of preparing the same, and a composition including the same.

### BACKGROUND ART

In various electronic products, such as computers, semiconductors, displays, and communications devices, a printed circuit board (PCB) having a specific electronic circuit printed thereon is being used.

On the board, there may be formed signal lines for signal transmission, insulating layers to prevent shorting between lines, switching elements, and the like.

The PCB may be manufactured by a method in which a glass cloth is impregnated with an epoxy resin and then semi-cured prepregs are deposited on internal layers of the circuit board having circuits formed thereon.

Alternatively, the PCB may be manufactured by a build-up technique which produces the boards by laminating insulating layers in an alternating fashion on circuit patterns on internal layers of the circuit board having circuits formed thereon.

Here, the build-up technique increases wiring density by via-hole formation and forms circuitry by laser machining and the like, and thus, is advantageous in increasing PCB density and reducing PCB thickness.

As PCB densities and complexities are increased in line with the recent trend towards lightweight, thin, short, and small-sized electronic devices, the electrical, thermal, and mechanical stability of PCBs are increasingly important factors in the stability and reliability of electronic devices.

There is an increasing need to realize high wiring density through wire pitch reduction in PCBs, in line with the trend of electronic devices being increasingly smaller and thinner and having higher performance.

To this end, instead of the existing wire-bonding method, a flip-chip bonding method in which semiconductor devices are attached to circuit boards by solder balls is often used.

Since in a flip-chip bonding method, circuit boards and semiconductor devices are bonded together by placing solder balls therebetween and heating the entire assembly to cause the solder to reflow, the flip-chip bonding method requires insulating materials of higher non-flammability.

Furthermore, in line with the high performance requirement in electronic devices as described above, there is a trend that signals inside such electronic devices are increasingly of higher speeds and higher frequencies.

Transmission losses of electrical signals are proportional to dielectric dissipation factor (D_{f}) and frequency.

At higher frequencies, transmission losses are greater, causing signal attenuation and thus degrading the reliability of signal transmission.

Also, such transmission losses may be converted to heat, causing heating issues.

Therefore, there is need for insulating materials with smaller permittivity and dielectric loss coefficient than insulating materials of the related art.

However, due to the inherent characteristics of epoxy resin compositions and their cured products, which are widely used as insulating materials in the related art, it is not easy to lower permittivity and dielectric loss coefficient.

### DESCRIPTION OF EMBODIMENTS

### Technical Problem

In light of the above, the present inventors have investigated the above-described issues from multiple view points, and as a result, found that the use of an unsaturated group-containing resin including alkali metal ions in an amount in a predetermined range and a certain level of oligomers lowers permittivity and dielectric loss coefficient, while improving glass transition temperature characteristics.

In addition, another objective of the present disclosure is to provide a method of preparing a resin, which has reduced production costs, a high productivity, and an improved production yield by removing impurities through water separation by reaction with a solvent.

### Solution to Problem

One aspect of the present disclosure provides an unsaturated group-containing resin including an oligomer represented by Chemical Formula 1 and an alkali metal ion, wherein an amount of the oligomer with n being 0 in Chemical Formula 1 is 80 wt % or less with respect to the total weight of the resin, and an amount of the alkali metal ion is 1 ppm to 30 ppm.

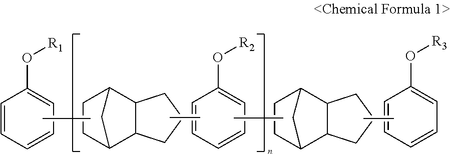

In Chemical Formula 1,

n is an integer selected from 0 to 10,

R₁ to R₃ are each independently hydrogen, a C₁-C₂₀ alkyl group that is unsubstituted or substituted with at least one R′, a C₂-C₂₀ alkenyl group that is unsubstituted or substituted with at least one R′, or a C₂-C₂₀ alkynyl group that is unsubstituted or substituted with at least one R′, wherein at least one of R₁ to R₃ contains one or more unsaturated groups,

R′ is: deuterium, —F, —Cl, —Br, or —I; or a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, or a C₆-C₂₀ aryl group, each being unsubstituted or substituted with deuterium, —F, —Cl, —Br, —I, a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, a C₆-C₂₀ aryl group, or any combination thereof.

Another aspect of the present disclosure provides a method of preparing an unsaturated group-containing resin, the method including: (A) preparing a first mixture solution by reacting a compound represented by Chemical Formula 10-1 with a halide compound represented by Chemical Formula 10-2 in the presence of a reaction solvent;

(B) preparing a second mixture solution by neutralizing the first mixture solution;

and (C) preparing a resin by water separation of the second mixture,

wherein the reaction solvent is methyl ethyl ketone (MEK), methyl isobutyl ketone (MIBK), a cyclic hydrocarbon, a ring-containing ketone, an aliphatic alcohol, an alkyl acetate, or a mixture thereof, and the unsaturated group-containing resin contains an oligomer represented by Chemical Formula 1.

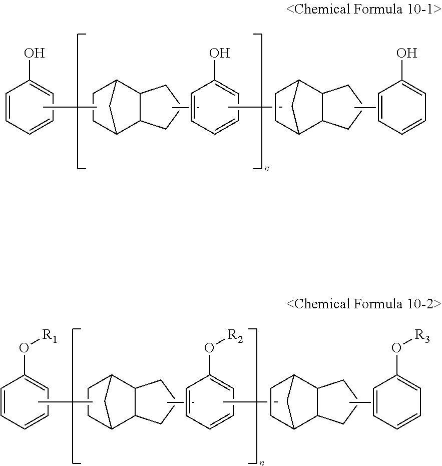

In Chemical Formula 1 and Chemical Formulas 10-1 and 10-2,

n is an integer selected from 0 to 10,

R₁ to R₃ and Rio are each independently hydrogen, a C₁-C₂₀ alkyl group that is unsubstituted or substituted with at least one R′, a C₂-C₂₀ alkenyl group that is unsubstituted or substituted with at least one R′, or a C₂-C₂₀ alkynyl group that is unsubstituted or substituted with at least one R′, wherein at least one of R₁ to R₃ contains one or more unsaturated groups, X is a halogen, and

R′ is: deuterium, —F, —Cl, —Br, or —I; or a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, or a C₆-C₂₀ aryl group, each being unsubstituted or substituted with deuterium, —F, —Cl, —Br, —I, a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, a C₆-C₂₀ aryl group, or any combination thereof.

Another aspect of the present disclosure provides a composition including the above-described unsaturated group-containing resin; a curing agent; and a curing accelerator.

### Advantageous Effects of Disclosure

According to the present disclosure, an unsaturated group-containing resin, by containing an alkali metal ion in an amount in a predetermined range and a certain level of oligomers, may have lowered permittivity and dielectric loss coefficient and improved glass transition temperature characteristics.

In addition, the present disclosure may provide a method of preparing a resin, which has reduced production costs, a high productivity, and an improved production yield, by removing impurities through water separation by reaction with a solvent.

### BRIEF DESCRIPTION OF DRAWINGS

FIG. 1 is a result of gel permeation chromatography of a resin according to Example 1.

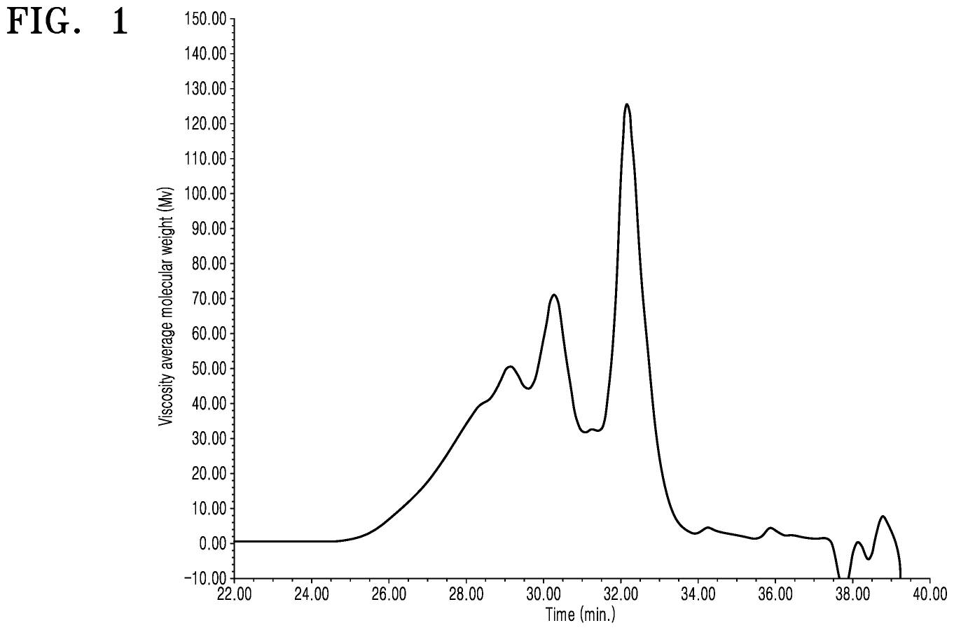

### MODE OF DISCLOSURE

Hereinbelow, various examples of the present disclosure will be described in greater detail so that one of ordinary skill in the art in the technical field to which the present disclosure belongs can easily implement the present disclosure.

The present disclosure may be implemented in various different forms and is not limited to the examples described herein.

Parts irrelevant to the description will be omitted to clearly describe the present disclosure, and throughout this specification, the same reference numerals have been employed for the same or equivalent elements or features.

Also, throughout this specification, unless clearly indicated otherwise, the terms “comprises” and/or “comprising,” or “includes” and/or “including”, specify the presence of stated elements or features, but do not preclude the presence or addition of one or more other elements or features.

As used in this specification, the term “C₁-C₂₀ alkyl group” refers to a monovalent group of linear or branched aliphatic hydrocarbons having 1 to 20 carbon atoms.

The C₁-C₂₀ alkyl group may preferably have 1 to 10 carbon atoms, and more preferably have 1 to 8 carbon atoms.

The C₁-C₂₀ alkyl group may include, not only unsubstituted such groups, but also groups that are further substituted with a substituent group described below.

Specific examples of the C₁-C₂₀ alkyl group include methyl group, ethyl group, n-propyl group, isopropyl group, n-butyl group, sec-butyl group, isobutyl group, tert-butyl group, n-pentyl group, tert-pentyl group, neopentyl group, isopentyl group, sec-pentyl group, 3-pentyl group, sec-isopentyl group, n-hexyl group, isohexyl group, sec-hexyl group, tert-hexyl group, n-heptyl group, isoheptyl group, sec-heptyl group, tert-heptyl group, n-octyl group, isooctyl group, sec-octyl group, tert-octyl group, n-nonyl group, isononyl group, sec-nonyl group, tert-nonyl group, n-decyl group, isodecyl group, sec-decyl group, tert-decyl group, and the like.

As used in this specification, the term “C₂-C₂₀ alkenyl group” refers to a linear or branched monovalent hydrocarbon group having one or more carbon-carbon double bonds and containing 2 to 20 carbon atoms, preferably 2 to 10 carbon atoms, and more preferably, 2 to 6 carbon atoms.

The alkenyl group may be linked via a carbon atom containing a carbon-carbon double bond, or via a saturated carbon atom.

The alkenyl group may include, not only unsubstituted such groups, but also groups that are further substituted with a substituent group described below.

Examples of the alkenyl group may include a vinyl group (ethenyl group), 1-propenyl group, 2-propenyl group, 2-butenyl group, 3-butenyl group, pentenyl group, 5-hexenyl group, dodecenyl group, and the like.

As used in this specification, the term “C₂-C₂₀ alkynyl group” refers to a linear or branched monovalent hydrocarbon group having one or more carbon-carbon triple bonds and containing 2 to 20 carbon atoms, preferably 2 to 10 carbon atoms, and more preferably, 2 to 6 carbon atoms.

The alkynyl group may be linked via a carbon atom containing a carbon-carbon triple bond, or via a saturated carbon atom.

The alkenyl group may include groups that are further substituted with a substituent group described below.

For example, the alkynyl group may include an ethynyl group, a propynyl group, and the like.

As used in this specification, the term “C₁-C₁₀ alkoxy group” refers to a monovalent group having the chemical formula of —OA₁₀₁ (here, A₁₀₁ is the above C₁-C₁₀ alkyl group), and specific examples of such groups include a methoxy group, an ethoxy group, an isopropyloxy group, and the like.

As used in this specification, the term “C₃-C₁₀ cycloalkyl group” refers to a saturated or unsaturated monovalent monocyclic, bicyclic, or tricyclic nonaromatic hydrocarbon group of 3 to 10 carbon rings, and may include groups that are further substituted with a substituent group described below.

For example, such groups may include a cyclopropyl group, a cyclobutyl group, a cyclopentyl group, a cyclohexyl group, a cycloheptyl group, a cyclooctyl group, an adamantanyl group, a norbornanyl group (or, bicyclo[2.2.1]heptyl group), bicyclo[1.1.1]pentyl group, bicyclo[2.1.1]hexyl group, bicyclo[2.2.2]octyl group, and the like.

As used in this specification, the term “C₆-C₂₀ aryl group” refers to a monovalent monocyclic, bicyclic, or tricyclic aromatic hydrocarbon group having 6 to 20 ring atoms, and may include groups that are further substituted with a substituent group described below.

Examples of the aryl group may include a phenyl group, a pentalenyl group, a naphthyl group, an azulenyl group, an indacenyl group, an acenaphthylenyl group, a phenalenyl group, a phenanthenyl group, an anthracenyl group, a fluoranthenyl group, a triphenylenyl group, a pyrenyl group, a chrycenyl group, a perylenyl group, a pentaphenyl group, a heptalenyl group, a naphthacenyl group, a picenyl group, a hexacenyl group, a pentacenyl group, a rubicenyl group, a coronenyl group, an ovalenyl group, and the like.

All compounds or substituent groups disclosed in this specification may be substituted or unsubstituted, unless otherwise indicated.

Here, the term “substituted” means a hydrogen atom being replaced with one selected from among deuterium, —F, —Cl, —Br, —I, a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, or a C₆-C₂₀ aryl group; and a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, or a C₆-C₂₀ aryl group, each being substituted with at least one selected from among deuterium, —F, —Cl, —Br, —I, a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, and a C₆-C₂₀ aryl group.

In this specification, “ICP-OES” analyses were performed under the following conditions:
Flush Pump rate: 40 rpm
Analysis Pump rate: 40 rpm
RF Power: 1350 W
Auxiliary Gas Flow: 1 L/min
Nebulizer Gas Flow: 0.4 L/min
Coolant Gas flow: 14 L/min
Additional Gas Flow: 0.1 L/min

In this specification, “GC” analyses were performed under the following conditions:
Column: HP-5 (Agilent), 0.25 μm, 30 m×0.320 mm
Injection: Split Ratio 50, Total flow 56 ml/min, Pressure 80.9 kPa
Temperature: Oven Temp 60° C.=>5 min Holding->280° C. (20° C./min) [symbol] 5 min Holding Injection Temp 280° C.
Carrier Gas: N₂ 20 ml/min, H2 30 ml/min, Air 30 ml/min
Detector: 300° C., FID
Injection Volume: 1 μL
Sample: 0.1-0.15 g/20 ml (THF)
Run Time: 25 min

The unsaturated group-containing resin according to one aspect of the present disclosure includes an oligomer represented by Chemical Formula 1 below and an alkali metal ion, and an amount of the oligomer with n being 0 in Chemical Formula 1 is 80% or less with respect to the total weight of the resin, and an amount of the alkali metal ion is 1 ppm to 30 ppm.

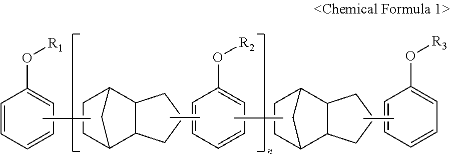

Here, the amount of the oligomer with n being 0 may be analyzed by gel permeation chromatography (GPC).

Here, the amount of the alkali metal ion may be analyzed by inductively coupled plasma optical emission spectrometry (ICP-OES).

Generally, unsaturated group-containing resins, when containing alkali metal ions (sodium ions, potassium ions, etc.) have diminished insulating properties and reduced reliability, and thus are not preferable.

However, the inventors of the present application have found that the inclusion of an alkali metal ion in an amount in a predetermined range exerts less influence on reliability and insulating properties, and rather, has the effect of improving heat resistance.

As described above, an unsaturated group-containing resin of the present disclosure may have the effect of improving heat resistance as the amount of the alkali metal ion satisfies the range of 1 ppm to 30 ppm.

For example, the unsaturated group-containing resin may have the amount of the alkali metal ion in a range of 5 ppm to 20 ppm.

If the amount of the alkali metal ion is less than 1 ppm, departing from the above range, the effect of improving heat resistance may not be to a satisfactory level. If the amount of the alkali metal ion exceeds 30 ppm, electrical insulation and reliability may be diminished, and heat resistance may also be diminished.

According to one example, the alkali metal ion may be a Na ion, a K ion, or any combination thereof.

For example, the alkali metal ion may be a Na ion.

According to one example, the unsaturated group-containing resin may contain a vinyl benzyl halide in an amount of 3,000 ppm or less.

For example, the vinyl benzyl halide may be vinyl benzyl chloride (VBC).

Here, the amount of the vinyl benzyl halide may be analyzed by gas chromatography (GC).

When the amount of the vinyl benzyl halide exceeds 3,000 ppm, there are issues that electrical reliability and insulation properties are reduced.

For example, the amount of vinyl benzyl halide in resin may be 1 ppm to 3,000 ppm.

In Chemical Formula 1, R₁ to R₃ are each independently hydrogen, a C₁-C₂₀ alkyl group that is unsubstituted or substituted with at least one R′, a C₂-C₂₀ alkenyl group that is unsubstituted or substituted with at least one R′, or a C₂-C₂₀ alkynyl group that is unsubstituted or substituted with at least one R′, wherein at least one of R₁ to R₃ contains one or more unsaturated groups.

According to one example, R₁ to R₃ may contain one or more unsaturated groups.

For example, R₁ to R₃ may be identical or different from one another.

According to one example, R₁ to R₃ may be a C₁-C₂₀ alkyl group that is substituted with a C₆-C₂₀ aryl group substituted with a C₂-C₁₀ alkenyl group.

According to one example, R₁ to R₃ may be each independently selected from groups represented by Chemical Formulas 2-1 to 2-3 below:

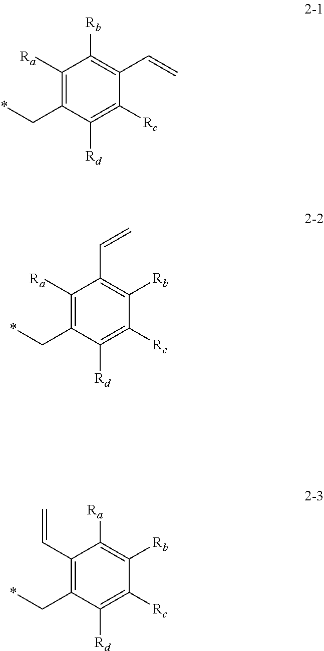

In Chemical Formulas 2-1 to 2-3,

Rₐ to R_{c} may be each independently hydrogen, deuterium, —F, —Cl, —Br, —I, a C₁-C₁₀ alkyl group, a C₂-C₁₀ alkenyl group, a C₂-C₁₀ alkynyl group, or a C₁-C₁₀ alkoxy group, wherein
● is a binding site with an adjacent atom.

For example, the unsaturated group-containing resin may be represented by Chemical Formula 1A below.

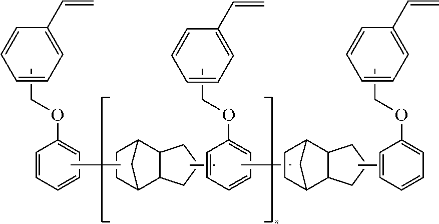

n is an integer selected from 0 to 10.

In Chemical Formula 1, n is an integer selected from 0 to 10.

For example, n may be an integer selected from 0 to 5.

According to one example, in Chemical Formula 1, an amount of the oligomer with n being 0 may be 80 wt % or less with respect to the total weight of the resin.

As the amount of the oligomer with n being 0 is 80 wt % or less, there may be an effect of further reducing permittivity and further increasing a glass transition temperature.

For example, the amount of the oligomer with n being 0 may be 20 wt % to 80 wt % with respect to the total weight of the resin.

According to one example, the unsaturated group-containing resin may have a weight average molecular weight (M_{w}) of 500 g/mol to 4,000 g/mol.

The above weight average molecular weight is relevant to the field to which the unsaturated group-containing resin is applied, and for example, may be in a range that sufficiently realizes its functions when applied to the field of electronic materials.

When the weight average molecular weight is less than the above range, there may be difficulty in usage due to unsatisfactory compatibility with other resins. In contrast, when the weight average molecular weight exceeds the above range, compatibility with solvents may be diminished, and electrical insulation properties and reliability may be diminished, thus making it difficult to find its applications.

A method of preparing an unsaturated group-containing resin according to another aspect of the present disclosure comprises: (A) preparing a first mixture solution by reacting a compound represented by Chemical Formula 10-1 with a halide compound represented by Chemical Formula 10-2 in the presence of a reaction solvent;

(B) preparing a second mixture solution by neutralizing the first mixture solution;

and (C) preparing a resin by water separation of the second mixture,

wherein the reaction solvent may be methyl ethyl ketone (MEK), methyl isobutyl ketone (MIBK), a cyclic hydrocarbon, a ring-containing ketone, an aliphatic alcohol, an alkyl acetate, or a mixture thereof,

and the resin includes an oligomer represented by Chemical Formula 1:

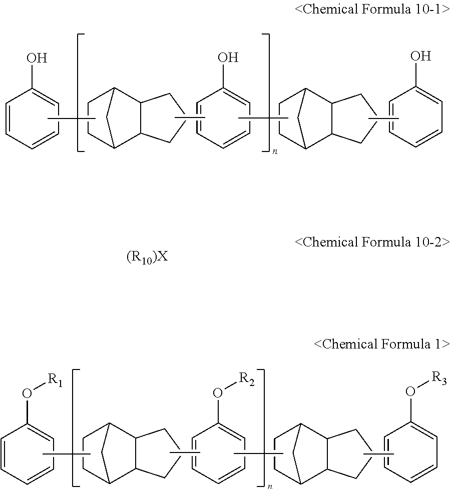

In Chemical Formula 1 and Chemical Formula 10-1, n and R₁ to R₃ may be understood with reference to the description above,

and in Chemical Formula 10-2, Rio may be understood with reference to the descriptions of R₁ to R₃.

The cyclic hydrocarbon may be benzene, toluene, xylene, ethyl toluene, cyclohexane, or a combination thereof.

The ring-containing ketone may be acetohexane, acetophenone, cyclohexanone, cycloheptanone, cyclopentanone, or a combination thereof.

The aliphatic alcohol may be a methanol, 1-methoxy-2-propanol, 2-methoxy ethanol, a propyl alcohol, an isopropyl alcohol, a butyl alcohol, an isobutyl alcohol, or a combination thereof.

The alkyl acetate may be an ethyl acetate, a propyl acetate, an isobutyl acetate, or a combination thereof.

In Chemical Formula 10-2, X is a halogen.

For example, X may be —F, —Cl, —Br, or —I.

For example, X may be —Cl.

According to one example, after (C), (D) of removing impurities via water separation after neutralization may be further included.

According to one example, in (A), a molar ratio of the compound represented by Chemical Formula 10-1 and the halide compound may be 1:0.7 to 1:1.5.

For example, the reaction in (A) may be carried out at a temperature of 40° C. to 80° C.

When the temperature is less than 40° C., it may consume a long time for resin preparation due to too slow a reaction rate, and when the temperature exceeds 80° C., it may give rise to overreaction due to too fast a reaction rate, and thus is not preferable.

According to one example, (A) may be carried out in the presence of an alkali metal catalyst.

For example, the alkali metal catalyst may be NaOH, KOH, or a mixture thereof.

The amount of the alkali metal catalyst may be 0.001 wt % to 50 wt %.

According to one example, (B) may be carried out in the presence of a neutralizing agent, which includes but is not limited to, inorganic acids, such as sulfuric acid, phosphoric acid, and hydrochloric acid, and metal phosphates and the like.

For example, the neutralizing agent may be a metal phosphate.

For example, the metal phosphate may be NaH₂PO₄, Na₂HPO₄, or a mixture thereof.

According to one example, (D) may utilize water alone, for water separation.

According to another example, (D) may facilitate the water separation by further using, in addition to water, an aliphatic alcohol having 2 to 6 carbon atoms (ethanol, isopropanol, n-butanol, etc.).

Here, the ratio of the water to an aprotic polar solvent may be between 100:0 to 40:60.

Generally, in producing DCPD-phenolic resins containing unsaturated groups, an antisolvent precipitation method using methanol, etc. is used. However, this method gives rise to issues of high processing costs, low per-unit productivity, and low production yields.

In addition, when acetone is used as a solvent, there is an issue that water separation cannot be carried out.

By using MEK, MIBK, a cyclic hydrocarbon, a ring-containing ketone, an aliphatic alcohol, an alkyl acetate, or a mixture solvent containing these components, as a reaction solvent, the method of preparing a resin according to the present disclosure can remove impurities via water separation in the presence of a reaction solvent, instead of a precipitation method.

In addition, through neutralization, it is possible to reduce the processing costs and improve productivity and production yields.

An unsaturated group-containing resin composition according to another aspect of the present disclosure includes the unsaturated group-containing resin described above; a curing agent; and a curing accelerator.

According to one example, the unsaturated group-containing resin composition may have a glass transition temperature (T_{g}) of 160° C. to 190° C.

For example, the unsaturated group-containing resin composition may have a glass transition temperature (T_{g}) of 170° C. to 190° C., but is not limited thereto.

The glass transition temperature is a value measured using TMA by plotting, over temperature, an expansion amount of material as a sample cut to a thickness of 5-10 mm, being heated under a predetermined temperature elevation condition, undergoes phase changes.

Within the above range of glass transition temperature, the unsaturated group-containing resin composition may have excellent heat resistance.

The unsaturated group-containing resin composition may have a permittivity (Dₖ) of less than 3.7 at 10 GHz.

Also, the unsaturated group-containing resin composition may have a dielectric loss factor (D_{f}) of less than 0.006 at 10 GHz.

With respect to 100 parts by weight of the unsaturated group-containing resin, 0.1 to 50 parts by weight of a curing agent and 0.0001 to 0.05 parts by weight of a curing accelerator may be included.

When the curing agent is included within the above range, an appropriate curing rate can be achieved.

When the curing accelerator is in an amount of less than 0.0001 parts by weight, it may prevent the curing reaction from taking place properly, and when the curing accelerator is in an amount of more than 0.05 parts by weight, it may give rise to overreaction, and thus is not preferable.

The curing agent may be one commonly used in the field to which the present disclosure belongs, and for example, may be triallyl isocyanurate (TAIC), bismaleimide, isocyanurate, and the like.

For example, isocyanurate, bismaleimide, and a mixture thereof may be used, and for example, TAIC may be used.

Likewise, the curing accelerator may be one commonly used in the field to which the present disclosure belongs, and examples of the curing accelerator include peroxides such as dicumyl peroxide (DCP), benzoyl peroxide, and the like, and common radical initiators such as azobisisobutyronitrile and the like.

As the unsaturated group-containing resin included in the composition has low permittivity and high glass transition temperature, the composition according to the present disclosure as described above has improved insulation properties and heat resistance, and thus may be utilized in any field that requires the use of insulating materials.

In this specification, “R′” is: deuterium, —F, —Cl, —Br, or —I; or C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, or a C₆-C₂₀ aryl group, each being unsubstituted or substituted with deuterium, —F, —Cl, —Br, —I, a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, a C₆-C₂₀ aryl group, or any combination thereof.

Hereinbelow, Manufacturing Examples, Examples, Comparative Examples, and Experiment Examples are shown to aid in understanding the effects of the present disclosure.

However, the description below merely describes one example of the content and effects of the present disclosure and therefore shall not be construed as limiting the scope and effects of the present disclosure.

### EXAMPLES

### Example 1: Preparation of Unsaturated Group-Containing Resin 1

In a three-necked 3 L flask purged with nitrogen, 300 g of DCPD-Phenol (KOLON INDUSTRIAL Co., Ltd., KPE-F6135, oligomer with n=0 (n=0 portion): 25 wt %) and 1,000 g of MEK were added, and after adding 330 g of vinylbenzyl chloride (VBC, ortho:para=2:8) thereto, the temperature was raised to 50° C.

Subsequently, 200 g of 50% sodium hydroxide aqueous solution was slowly added over 2-3 hours.

After the addition, the contents of the flask were left to react at 50° C. for 24 hours and then cooled.

After the cooling, the resulting contents of the flask were neutralized with NaHPO₄, and water separation was carried out by adding hot water.

Subsequently, after removing unreacted materials and byproducts by adding hot water multiple times, the MEK solvent was removed by degassing under vacuum.

The yield was 498 g, the Na content was 15 ppm, the residual vinyl benzyl chloride was 2,000 ppm, the n=0 portion was 25%, and the molecular weight was 1,430 g/mol.

### Example 2: Preparation of Unsaturated Group-Containing Resin 2

The process described in Example 1 was performed under the same conditions, except using DCPD-Phenol (KOLON INDUSTRIAL Co., Ltd., KPE-F6115, n=0 portion: 40 wt %).

The yield was 492 g, the Na content was 10 ppm, the residual vinyl benzyl chloride was 1,840 ppm, the n=0 portion was 40%, and the molecular weight was 1,120 g/mol.

### Example 3: Preparation of Unsaturated Group-Containing Resin 3

The process described in Example 1 was performed under the same conditions, except using DCPD-Phenol (KOLON INDUSTRIAL Co., Ltd., KPE-F6095, n=0 portion: 70 wt %).

The yield was 495 g, the Na content was 14 ppm, the residual vinyl benzyl chloride was 2,620 ppm, the n=0 portion was 70%, and the molecular weight was 834 g/mol.

### Comparative Example 1: Resin Prepared Using DCPD-Phenol

The process described in Example 1 was performed under the same conditions, except using DCPD-Phenol (n=0 portion: 100 wt %).

The yield was 493 g, the Na content was 16 ppm, the residual vinyl benzyl chloride was 1,950 ppm, the n=0 portion was 100%, and the molecular weight was 495 g/mol.

### Comparative Example 1: Resin Prepared Using DCPD-Cresol

The same process described in Example 1 was performed under the same conditions, except using DCPD-cresol (n=0 portion: 100 wt %).

The yield was 496 g, the Na content was 17 ppm, the residual vinyl benzyl chloride was 2,340 ppm, the n=0 portion was 100%, and the molecular weight was 534 g/mol.

### Comparative Example 3: Resin Prepared Using Anti-Solvent

In view of a method disclosed in Examples in U.S. Pat. No. 4,824,920, the preparation was carried out using KOLON INDUSTRIAL Co., Ltd., KPE-F6115 (n=0 portion: 40 wt %).

The yield was 450 g, the Na content was 0.5 ppm, the residual vinyl benzyl chloride was 1,650 ppm, the n=0 portion was 40%, and the molecular weight was 1,142 g/mol.

Preparation of Resin Composition

A composition (varnish) using the resins according to Examples 1 to 3 and Comparative Examples 1 to 3 was prepared by mixing the amounts disclosed in Table 1 below.

The process for preparing the varnish is described in detail below.

Triallyl isocyanurate (TAIC), which is polyfunctional, was used as a curing agent, and dicumyl peroxide (DCP) was used as a curing accelerator.

Also, MEK was additionally added to realize 60 wt % solids content of the varnish.

Mixing ratios for the composition using the resins prepared in Examples 1 to 3 and Comparative Examples 1 to 3 are shown in Table 1 below.

TABLE 1

| | Example | Example | Example | Comparative | Comparative | Comparative |
|---|---|---|---|---|---|---|
| | 1 | 2 | 3 | Example 1 | Example 2 | Example 3 |
| Resin (g) | 15 | 15 | 15 | 15 | 15 | 15 |
| TAIC (g) | 15 | 15 | 15 | 15 | 15 | 15 |
| DCP (g) | 0.075 | 0.075 | 0.075 | 0.075 | 0.075 | 0.075 |
| MEK (g) | 19 | 19 | 19 | 19 | 19 | 19 |

Evaluation Example 1: Measurement of Weight Average Molecular Weight (M_{w})

Gel permeation chromatography (GPC) (waters: waters 707) was used to obtain a polystyrene-converted weight average molecular weight (M_{w}).

A polymer to be measured was dissolved in tetrahydrofuran to a concentration of 4,000 ppm and injected into GPC in an amount of 100 μL.

Using tetrahydrofuran as a mobile phase of GPC, injections were made at a flow rate of 1.0 mL/min. and analyses were performed at 35° C.

Waters HR-05, 1, 2, and 4E were connected in series and used for columns.

Using RI and PAD detectors as detection devices, measurements were made at 35° C.

Evaluation Example 2: Measurement of Na Content

Na contents were measured by ICP-OES analyses under the following conditions.

Flush Pump rate: 40 rpm

Analysis Pump rate: 40 rpm

RF Power: 1350 W

Auxiliary Gas Flow: 1 L/min

Nebulizer Gas Flow: 0.4 L/min

Coolant Gas flow: 14 L/min

Additional Gas Flow: 0.1 L/min

Evaluation Example 3: Measurement of Permittivity

(1) Preparation of Prepreg

Glass cloth was impregnated with a varnish using the resins prepared in Examples 1 to 3 and Comparative Examples 1 to 3, and dried in the open air for 1 hour, and then dried in an oven at 155° C., to produce a prepreg.

(2) Preparation of Copper Clad Laminate

The preparation was made by stacking three sheets of the above-prepared prepreg together, covering the front and back of the stack with a copper foil (1 once), and pressing the stack for 120 minutes under a pressure of 40 kgf/cm² at 195° C.

(3) Measurement of Permittivity

After cutting the above-prepared copper clad laminate to 1 cm×1 cm and removing the copper foil therefrom, dielectric constant (Dₖ) and dielectric loss (D_{f}) were measured under a condition of 10 GHz using AET. INC CDMS100.

Specific measurement conditions were as follows.

Measurement frequency: 10 GHz

Measurement temperature: 25-27° C.

Measurement humidity: 45-55%

Measurement sample thickness: 5-10 mm

Evaluation Example 4: Measurement of glass transition temperature (T_{g})

After cutting the copper clad laminate prepared in Evaluation Example 3 to 5 mm×5 mm, and removing the copper foil therefrom, measurements were made using TMA Q400 manufactured by TA Instruments.

Specific measurement conditions were as follows.

Measurement temperature: 25-300° C.

Temperature elevation: 10° C./MIN

Measurement humidity: 45-55%

Measurement sample thickness: 5-10 mm

Properties measured by the above method are shown in Table 2 below.

TABLE 2

| | Example | Example | Example | Comparative | Comparative | Comparative |
|---|---|---|---|---|---|---|
| | 1 | 2 | 3 | Example 1 | Example 2 | Example 3 |
| n = 0 | 25 | 40 | 70 | 100 | 100 | 40 |
| portion (wt %) | | | | | | |
| Mw (g/mol) | 1430 | 1120 | 834 | 495 | 534 | 1142 |
| Yield (g) | 498 | 492 | 495 | 493 | 496 | 450 |
| Na content | 15 | 10 | 14 | 16 | 17 | 0.5 |
| (ppm) | | | | | | |
| Df | 3.4 | 3.4 | 3.5 | 3.7 | 3.6 | 3.4 |
| Dk | 0.004 | 0.004 | 0.005 | 0.007 | 0.006 | 0.004 |
| Tg (° C.) | 182 | 179 | 173 | 168 | 165 | 175 |

As shown in Table 2, it was found that the resin compositions of Examples 1 to 3 have superior glass transition temperature and dielectric characteristics compared to the resin compositions of Comparative Examples 1 and 2.

This finding indicates that the amount of oligomers contribute to an improvement in dielectric characteristics and glass transition temperature.

In addition, it was found that, compared to Comparative Example 3, the resin of Example 2 has a higher yield, and shows similar dielectric characteristics, but a higher glass transition temperature.

This finding indicates that the preparation method according to the present disclosure is more efficient, and even with the same material, the amount of an alkali metal ion disclosed in the present disclosure leads to an improvement in glass transition temperature.

Accordingly, the unsaturated group-containing resin containing a certain level of oligomers and an alkali metal ion according to the present disclosure shows excellent effects on dielectric characteristics and glass transition temperature, and through a particular process, realizes not only a higher yield but also excellent characteristics as compared to the related art.

Simple modifications or changes in the present disclosure may be easily implemented by one of ordinary skill in the art in this field, and such modifications and changes shall be regarded as being within the scope of the present disclosure.

1. An unsaturated group-containing resin comprising:
an oligomer represented by Chemical Formula 1; and
an alkali metal ion, wherein an amount of the oligomer with n being 0 in Chemical Formula 1 is 80 wt % or less with respect to the total weight of the resin, and an amount of the alkali metal ion is 1 ppm to 30 ppm: 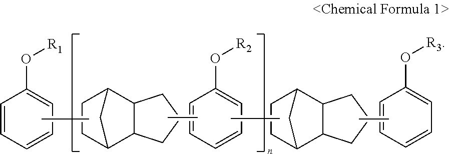
wherein in Chemical Formula 1, n is an integer selected from 0 to 10, R₁ to R₃ are each independently
hydrogen, a C₁-C₂₀ alkyl group that is unsubstituted or substituted with at least one R′,
a C₂-C₂₀ alkenyl group that is unsubstituted or substituted with at least one R′, or
a C₂-C₂₀ alkynyl group that is unsubstituted or substituted with at least one R′, wherein at least one of R₁ to R₃ contains
one or more unsaturated groups, and
R′ is: deuterium, —F, —C₁, —Br, or —I; or a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, or a C₆-C₂₀ aryl group, each being unsubstituted or substituted with deuterium, —F, —C₁, —Br, —I, a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, a C₆-C₂₀ aryl group, or any combination thereof.

2. The unsaturated group-containing resin of claim 1, wherein the alkali metal ion is a Na ion, a K ion, or any combination thereof.

3. The unsaturated group-containing resin of claim 1, comprising a vinyl benzyl halide in an amount of 3,000 ppm or less.

4. The unsaturated group-containing resin of claim 1, wherein R₁ to R₃ are each independently selected from among groups represented by Chemical Formulas 2-1 to 2-3: 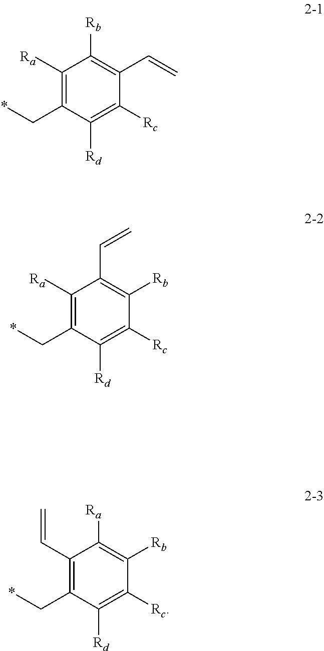
wherein in Chemical Formulas 2-1 to 2-3, Rₐ to R_{c} are each independently hydrogen, deuterium, —F, —Cl, —Br, —I, a C₁-C₁₀ alkyl group, a C₂-C₁₀ alkenyl group, a C₂-C₁₀ alkynyl group, or a C₁-C₁₀ alkoxy group, and * is a binding site with an adjacent atom.

5. The unsaturated group-containing resin of claim 1, wherein the unsaturated group-containing resin is represented by Chemical Formula 1A: 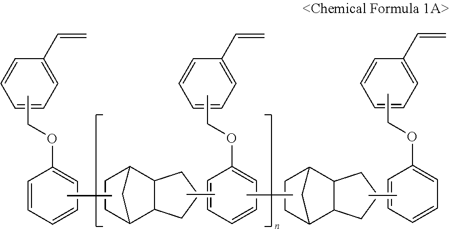
wherein n is an integer selected from 0 to 10.

6. The unsaturated group-containing resin of claim 1, wherein the unsaturated group-containing resin has a weight average molecular weight (M_{w}) of 500 g/mol to 4,000 g/mol.

7. A method of preparing an unsaturated group-containing resin, the method comprising:
(A) preparing a first mixture solution by reacting a compound represented by Chemical Formula 10-1 with a halide compound represented by Chemical Formula 210-2 in the presence of a reaction solvent;
(B) preparing a second mixture solution by neutralizing the first mixture solution; and
(C) preparing a resin by water separation of the second mixture, wherein the reaction solvent is methyl ethyl ketone (MEK), methyl isobutyl ketone (MIBK), a cyclic hydrocarbon, a ring-containing ketone, an aliphatic alcohol, an alkyl acetate, or a mixture thereof, and the unsaturated group-containing resin comprises an oligomer represented by Chemical Formula 1. 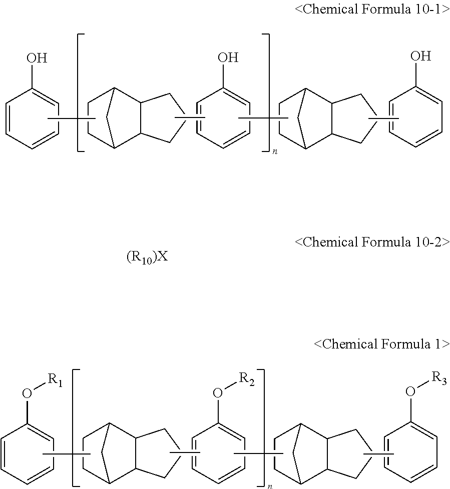
wherein in Chemical Formula 1 and Chemical Formulas 10-1 and 10-2, n is an integer selected from 0 to 10, R₁ to R₃ and Rio are each independently hydrogen, a C₁-C₂₀ alkyl group that is unsubstituted or substituted with at least one R′, a C₂-C₂₀ alkenyl group that is unsubstituted or substituted with at least one R′, or a C₂-C₂₀ alkynyl group that is unsubstituted or substituted with at least one R′, wherein at least one of R₁ to R₃ comprises one or more unsaturated groups, X is a halogen, and R′ is: deuterium, —F, —C₁, —Br, or —I; or a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, or a C₆-C₂₀ aryl group, each being unsubstituted or substituted with deuterium, —F, —C₁, —Br, —I, a C₁-C₁₀ alkyl group, a C₂-C₁₀ alkenyl group, a C₂-C₁₀ alkynyl group, a C₁-C₁₀ alkoxy group, a C₃-C₁₀ cycloalkyl group, a C₆-C₂₀ aryl group, or any combination thereof.

8. The method of preparing an unsaturated group-containing resin according to claim 7, the method further comprising, after (C), (D) removing impurities by water separation after neutralization.

9. The method of preparing an unsaturated group-containing resin according to claim 7, wherein in (A), a molar ratio of a compound represented by Chemical Formula 10-1 and a halide compound represented by Chemical Formula 10-2 is 1:0.7 to 1:1.5.

10. The method of preparing an unsaturated group-containing resin according to claim 7, wherein (A) is carried out in the presence of an alkali metal catalyst.

11. The method of preparing an unsaturated group-containing resin according to claim 10, wherein the alkali metal catalyst is NaOH, KOH, or a mixture thereof.

12. The method of preparing an unsaturated group-containing resin according to claim 7, wherein (B) is carried out in the presence of a neutralizing agent comprising an inorganic acid, a metal phosphate, or a mixture thereof.

13. The method of preparing an unsaturated group-containing resin according to claim 12, wherein the metal phosphate is NaH₂PO₄, Na₂HPO₄, or a mixture thereof.

14. An unsaturated group-containing resin composition comprising: the unsaturated group-containing resin according to claim 1; a curing agent; and a curing accelerator.

15. The unsaturated group-containing resin composition of claim 14, wherein the unsaturated group-containing resin composition has a glass transition temperature (T_{g}) of 160° C. to 190° C.

16. The unsaturated group-containing resin composition of claim 14, wherein the unsaturated group-containing resin composition comprises 0.1 to 50 parts by weight of the curing agent and 0.0001 to 0.05 parts by weight of the curing accelerator with respect to 100 parts by weight of the unsaturated group-containing resin.
